(19) United States
(12) Patent Application Publication
(10) Pub. No.: US 2006/0147072 A1
(43) Pub. Date: Jul. 6, 2006

(54) Open in-the-ear (ITE) hearing aid

(76) Inventors: Mark Thomas Sodoma, Brookfield, IL (US); George Szemborski, Roselle, IL (US)

Correspondence Address: Bingham McCutchen, LLP, Suite 1800, Three Embarcadero, San Francisco, CA, 94111-4067, US

(21) Appl. No.: 11/271,087

(22) Filed: Nov. 12, 2005

(30) Foreign Application Priority Data
Nov. 12, 2004 (DK) PA 2004 01751

(51) Int. Cl. H04R 25/00

(52) U.S. Cl. 381/328; 381/312

(57) ABSTRACT

According to the present invention, a hearing aid is provided having a housing with an open canal section that is adapted for fitting in the ear canal of a user and having a short vent the longitudinal extension of which is shorter than the longitudinal extension of the open canal section, and an output port for emission of sound towards the eardrum of the user when inserted in the ear canal, and a closed pinna section for enclosing hearing aid components and that is attached to the open canal section and adapted to be positioned outside the ear canal in front of the pinna when the open canal section is inserted in the ear canal, the short vent substantially preventing the occlusion effect.

### CROSS-REFERENCE TO RELATED APPLICATION

The present application claims priority from Danish Patent Application No. PA 2004 01751, filed Nov. 12, 2004, which is expressly incorporated herein by reference.

### FIELD OF THE INVENTION

The present invention relates to a new type of hearing aid housing having an open in-the-canal section.

### BACKGROUND OF THE INVENTION

A conventional in-the-ear (ITE) or completely-in-the-canal (CIC) hearing aid has a housing that is custom made to individually fit the user's ear canal. The hearing aid components, e.g. electronics, microphone, receiver, battery, etc., are contained in the housing which is closed at the end pointing out of the ear by a faceplate. In order to reduce occlusion, a so-called vent, i.e. a ventilation channel, may provide communication between an opening in the faceplate and the user's ear canal. The vent may be drilled through the housing or shell, or a pipe or tube extending within the hearing aid and connecting an opening in the faceplate with an opening at the opposite end of the housing may constitute the vent. The effectiveness of the vent increases with increased cross-section and decreased length of the vent channel.

Behind-the-ear (BTE) hearing aids in which a sound tube conducts sound generated by the receiver of the hearing aid into the ear canal are also well known in the art. In order to position the sound tube securely and comfortably in the ear canal, an earpiece is provided for insertion into the ear canal of the user.

Typically, the ITE or CIC housing or the BTE earpiece is individually custom manufactured to fit snugly in the ear canal of the user without causing pain to the user while still maintaining the housing or earpiece securely in place in the ear canal preventing the earpiece from falling out of the ear irrespective of movements of the user, such as chewing or yawning, and also avoiding acoustical feedback generating unpleasant and annoying whistling or howling. The custom made earpiece adds to the cost of the device and the time needed to fit the hearing aid.

In order to lower the manufacturing cost, it is known to manufacture the earpiece, shell, or earmould in a number of standard sizes to fit the human anatomy of the ear of most users.

Recently so-called “open” BTE earpieces have been introduced that affect the ear canal very little by avoiding blockage of the ear canal, i.e. the occlusion effect. This also assists in maintaining the natural hearing capacity and the physical environment of the user.

### SUMMARY OF THE INVENTION

It is an object of the present invention to provide an ITE hearing aid with a short vent, i.e. with a vent that is shorter than the distance from the bottom part of the housing to the faceplate and an enclosure for accommodation of hearing aid components.

According to the present invention, the above and other objects are fulfilled by provision of a hearing aid with a housing having an open canal section that is adapted for fitting in the ear canal of a user and having a short vent the longitudinal extension of which is shorter than the longitudinal extension of the open canal section, and an output port for emission of sound towards the eardrum of the user when inserted in the ear canal, and a closed pinna section for enclosing hearing aid components and that is attached to the open canal section and adapted to be positioned outside the ear canal in front of the pinna when the open canal section is inserted in the ear canal, the short vent substantially preventing the occlusion effect.

The fit of the open canal section may be provided by careful fitting of the canal section manufactured in a hard material, either by custom manufacturing as previously described or by provision of an appropriate number of standard sizes. Alternatively, manufacturing of the canal section of a soft material may provide the fit.

It is an important advantage of the present invention, that the vent may be very short, namely equal to the thickness of the wall of the canal section at the vent opening.

A tube, e.g. inside the canal section, may be provided wherein the inner volume of the tube communicates with the vent opening in the wall of the canal section for obtaining a desired length of the vent, e.g. equal to the sum of the length of the tube and the thickness of the wall. The length and diameter of the tube may be designed to obtain a desired low frequency gain. Although the vent with the tube will be longer than the thickness of the wall, it will remain much shorter than the longitudinal extension of the open canal section thereby maintaining a low occlusion level.

Preferably, the canal section is substantially empty leaving as much space available for the vent as possible, i.e. maximising the cross-section of the vent to minimize the occlusion effect. A few components may be located inside the canal section provided that sufficient space remains available for the vent to significantly reduce the occlusion effect. Such components may include, but is not limited to, a receiver, a sound tube, a cerumen filter, etc.

The pinna section provides an enclosure for accommodation of the hearing aid components. These components may include, but is not limited to, the microphone(s), amplifier, controls, electrical contacts and connectors, etc.

Further, the pinna section may be adapted to include a battery, such as a rechargeable battery. The rechargeable battery may be made from foils so that the rechargeable battery may be included in the wall of the hearing aid housing, such as in the wall of the pinna section. Alternatively, the pinna section may include a battery compartment for accommodation of a replaceable battery.

Preferably, the pinna section and the canal section form an integral housing that is manufactured in one piece.

Alternatively, the pinna section and the canal section are manufactured as separate parts that are interconnected mechanically and electrically during production of the hearing aid.

Sound signals may propagate as acoustic signal from a receiver positioned in the pinna section of the hearing aid and through a sound tube to an output opening at the end of the canal section for transmission of the sound to the eardrum in the ear canal. Alternatively, a moulded channel within the canal section may replace the sound tube.

Sound signals may alternatively propagate as electrical signals from the output of a signal processor in the pinna section to a receiver in the canal section that is positioned for emission of sound through the output port of the canal section.

In one embodiment of the invention, the hearing aid housing further comprises a helix section that is adapted to be positioned in the helix of the ear of the user and that is mechanically interconnected with the pinna section via a bridge section. The helix section, the bridge section and the pinna section preferably form an integral unit that is manufactured in one piece. Positioning of the microphone(s) of the hearing aid in the helix section creates a large distance between the microphone(s) and the receiver thereby minimizing feedback. Further, the helix section assists in retaining the housing in the ear of the user. The helix section and the bridge section may also accommodate hearing aid components.

The housing according to the present invention may be custom made for provision of the best possible individual fit of the hearing aid housing in the outer ear of the user, i.e. the canal section in the ear canal of the user, and of the pinna section outside the ear canal and in front of the pinna, e.g. in the concha of the ear of the user. Further, for embodiments with a helix section and a bridge section, these sections may also be customized to the corresponding parts of the ear of the user in question for provision of the best possible individual fit.

At a lower manufacturing cost, the housing according to the present invention is manufactured in a number of standard sizes to fit the human anatomy of the ear of most users.

In one embodiment of the invention, the canal part of the hearing aid housing is custom made while the remaining section(s) of the housing is (are) manufactured in a number of standard sizes.

In a preferred embodiment of the invention, feedback compensation is provided. Feedback refers to the amplified sound returning to the hearing aid microphone mainly via the vent or leaks around the hearing aid housing. Oscillation arises when the attenuation provided by the feedback path is smaller than the hearing aid gain. Since improved venting typically reduces the attenuation in the feedback path, the tendency to feedback oscillation is hereby also increased. Feedback is a well-known problem in hearing aids and several systems for suppression and cancellation of feedback exist within the art. With the development of very small digital signal processing (DSP) units, it has become possible to perform advanced algorithms for feedback suppression in a tiny device such as a hearing aid, see e.g. U.S. Pat. No. 5,619,580, U.S. Pat. No. 5,680,467 and U.S. Pat. No. 6,498,858.

The above mentioned prior art systems for feedback cancellation in hearing aids deal with external feedback, i.e. transmission of sound between the loudspeaker (often denoted receiver) and the microphone of the hearing aid along a path outside the hearing aid device. This problem, which is also known as acoustical feedback, occurs e.g. when a hearing aid earpiece does not completely fit the user's ear, or in the case of an earpiece comprising a vent. In both examples, sound may “leak” from the receiver to the microphone and thereby cause feedback.

The problem of external feedback limits the maximum gain available in a hearing aid.

Thus, the hearing aid may further comprise a feedback compensation circuit for providing a feedback compensation signal of signals picked up by the microphone by modelling an acoustical and mechanical feedback signal path of the hearing aid, subtracting means for subtracting the feedback compensation signals from the audio signal to form a compensated audio signal, which is input to the signal processor of the hearing aid.

The feedback signal path is typically an acoustic path between the microphone and the receiver, i.e. an external feedback signal propagates through air surrounding the hearing aid.

Preferably, the feedback compensation means comprises an adaptive filter, i.e. a filter that changes its impulse response in accordance with changes in the feedback path.

Both static and adaptive filters are well known to a person skilled in the art of hearing aids, and will therefore not be discussed in further detail here.

### BRIEF DESCRIPTION OF THE DRAWINGS

Below, the invention will be further described and illustrated with reference to the accompanying drawings in which:

FIG. 1 is a photo in perspective of a first embodiment of the invention,

FIG. 2 is a photo from the side of the embodiment shown in FIG. 1,

FIG. 3 is a photo of the embodiment of FIGS. 1 and 2 inserted in a model of an ear canal,

FIG. 4 is a photo of another embodiment of the invention inserted in a model of an ear canal,

FIG. 5 is a photo providing a side view of the hearing aid of FIG. 1, positioned in a user's right ear,

FIG. 6 is a photo providing a side view of the hearing aid of FIG. 4, positioned in a user's right ear, and

FIG. 7 shows a block-diagram of the electronic circuit of the embodiments shown in FIGS. 1-6 with a feedback compensation filter.

### DETAILED DESCRIPTION OF PREFERRED EMBODIMENTS

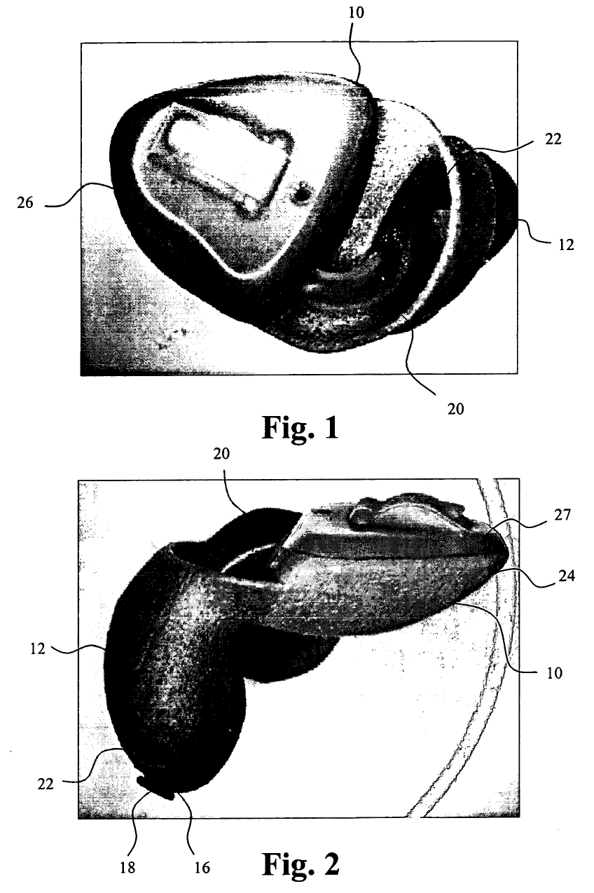

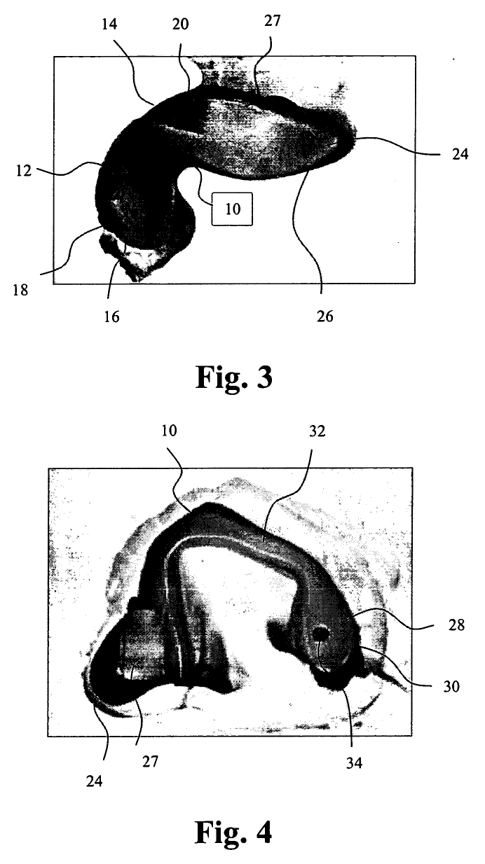

FIGS. 1-3 are photographs of a hearing aid according to a first embodiment of the present invention, having a housing 10 with an open canal section 12 that is adapted to be positioned in the ear canal 14 of a user comfortably fitting the ear canal 14 for retention of the housing 10 in the ear of the user. The canal section 12 has an output port 16 for emission of sound towards the eardrum of the user. In the illustrated embodiment, the output port 16 is equipped with a cerumen guard 18 hindering cerumen from entering the sound tube 20 of the hearing aid. The canal section 12 further has a vent 22 substantially eliminating the occlusion effect when the hearing aid housing is inserted into the ear canal of the user. The housing 10 further comprises a pinna section 24 that is attached to the canal section 12 for accommodation of hearing aid components and adapted for positioning at the concha 26 of the ear during use. The pinna section 24 is closed by a faceplate 27. The sound tube 20 provides a sound propagation path for sound signals emitted by a receiver (not shown) positioned in the pinna section 24 of the hearing aid to the output port 16 at the end of the canal section 12 for transmission of the sound to the eardrum (not shown) in the ear canal 14.

As clearly seen from FIG. 1, the vent 22 is very short, namely equal to the thickness of the wall of the canal section at the vent opening, and has a large cross-section whereby the occlusion effect is substantially eliminated.

The length of the vent may be extended by provision of a tube inside the canal section, the inner volume of the tube communicating with the vent opening in the wall providing a desired length of the vent that is equal to the sum of the length of the tube and the thickness of the wall. The length and diameter of the tube may be designed to obtain a desired low frequency gain of the vent. Although the vent with the tube will be longer than the thickness of the wall, it will remain much shorter than the longitudinal extension of the open canal section thereby maintaining a low occlusion level.

The pinna section 24 accommodates the hearing aid components (not shown), such as the microphone(s), amplifier, battery, controls, electrical contacts and connectors, etc.

In the illustrated embodiment, the pinna section 24 and the canal section 12 form an integral housing 10 that is manufactured in one piece.

FIG. 4 shows a photograph of another embodiment of the invention wherein the hearing aid housing 10 further comprises a helix section 28 that is adapted to be positioned in the helix 30 of the ear of the user and that is mechanically interconnected with the pinna section 24 with a bridge section 32. In the illustrated embodiment, the helix section 28, the bridge section 32 and the pinna section 24 form an integral unit 10 that is manufactured in one piece. Positioning of the microphone(s) (not shown) at the microphone input port 34 of the hearing aid in the helix section 28 creates a large distance between the microphone(s) and the receiver thereby minimizing feedback. Further, the helix section 28 assists in retaining the housing 10 in the ear of the user. The helix section 28 and the bridge section 32 may also accommodate hearing aid components.

Positioning of the microphone(s) of the hearing aid in the helix section 28 creates an increased distance between the microphone(s) and the output port 16 as compared to the corresponding distance in conventional ITE and CIC hearing aids whereby feedback is diminished.

For further suppression of the occlusion effect, the canal section may fitted so that it occupies only a part of the ear canal whereby the interior of the ear canal remains in communication with the surroundings upon insertion of the hearing aid housing in the ear canal. In this embodiment, the canal section may not contain a vent, since venting is provided by the non-occupied part of the ear canal.

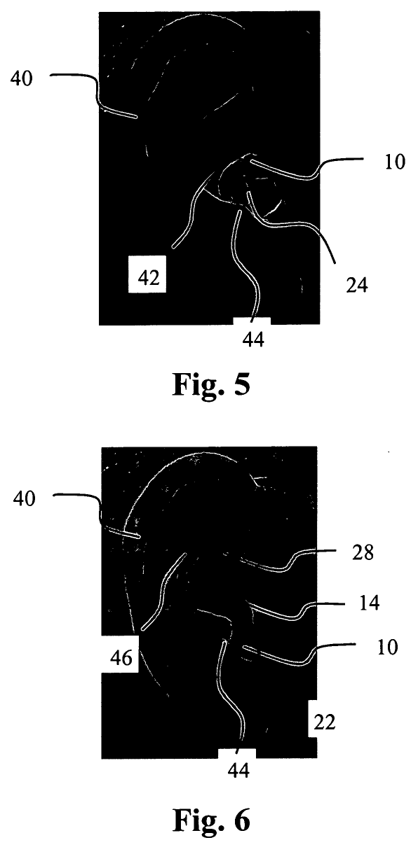

FIG. 5 is a photo that shows the embodiment shown in FIGS. 1-3 positioned in the ear of a user. In the illustrated embodiment, the pinna section 24 is adapted for abutting the pinna 40 in front of the pinna 40 at the concha 42 behind the antitragus 44 at which position the pinna section 24 is partly covered by the antitragus 44 and assists in providing secure retention of the housing 10 in the ear canal.

The illustrated hearing aid housing 10, the open canal section 12 and the pinna section 24 are custom made for provision of the best possible individual fit of the hearing aid housing to the outer ear of the user, i.e. the canal section in the ear canal of the user and the pinna section 24 in the concha 42 of the ear of the user. The custom made housing 10 is comfortable to wear and aesthetical and securely fastened in the ear canal of the user.

In another embodiment, the canal section 12 of the hearing aid housing 10 is custom made while the pinna section 24 is manufactured in a number of standard sizes.

FIG. 6 is a photo that shows the embodiment shown in FIG. 4 positioned in the ear of a user. In the illustrated embodiment, the pinna section 24 is adapted for abutting the pinna 40 in front of the pinna 40 at the concha 42 behind the antitragus 44 at which position the pinna section 24 is partly covered by the antitragus 44 and assists in providing secure retention of the housing 10 in the ear canal.

The hearing aid housing 10 further comprises the helix section 28 that is positioned under the antihelix 46 of the ear of the user. In the illustrated embodiment, the helix section 28, the bridge section 32 and the pinna section 24 form an integral unit 10 that is manufactured in one piece. The helix section 28 assists in retaining the housing 10 in the ear of the user.

For further suppression of the occlusion effect, the canal section is fitted so that it occupies only a part of the ear canal 14 whereby the interior of the ear canal 14 remains in communication with the surroundings upon insertion of the hearing aid housing 10 in the ear canal 14. In the illustrated embodiment, the canal section does not contain a vent, since venting is provided by the non-occupied part of the ear canal 14.

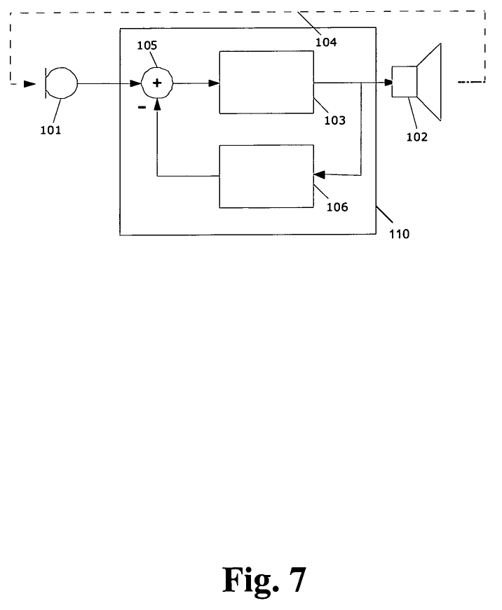

FIG. 7 is a block-diagram of the electronic circuit of the embodiments illustrated in FIGS. 1-6. The illustrated electronic components reside in the pinna section 24 of the hearing aid housing 10. The hearing aid 100 comprises a microphone 101 for receiving incoming sound and converting it into an audio signal. A receiver 102 converts output from the hearing aid signal processor 110 into output sound. The hearing aid signal processor 110 comprises various signal processing elements 103, such as amplifiers, compressors and noise reduction systems etc.

A feedback path 104 is shown as a dashed line between the receiver 102 and the microphone 101. This feedback path makes it possible for the microphone 101 to pick up sound from the receiver 102 which may lead to well known feedback problems, such as whistling. The hearing aid signal processor 110 further comprises a feedback compensation filter 106 and a subtraction circuit 105 for subtraction of the output of the filter 106 from the input signal for suppression of the feedback signal.

In the illustrated embodiments, sound signals propagate as acoustic signal from the receiver 102 positioned in the pinna section 24 of the hearing aid housing 10 through a sound tube 20 to the output opening 16 at the end of the canal section 12 for transmission of the sound to the eardrum in the ear canal.

In another embodiment, a moulded channel within the canal section replaces the sound tube.

In yet another embodiment, the receiver 102 resides in the open canal section 12 whereby the sound signals propagate as electrical signals from the output of the signal processor 110 in the pinna section 24 to the receiver 102 in the open canal section that is positioned for emission of sound through the output port 16 of the canal section.

1. A hearing aid with a housing having
an open canal section that is adapted for fitting in the ear canal of a user and having a short vent the longitudinal extension of which is shorter than the longitudinal extension of the open canal section, and an output port for emission of sound towards the eardrum of the user when inserted in the ear canal, and
a closed pinna section for enclosing hearing aid components and that is attached to the open canal section and adapted to be positioned outside the ear canal in front of the pinna when the open canal section is inserted in the ear canal, the short vent substantially preventing the occlusion effect.

2. A hearing aid according to claim 1, wherein the pinna section is adapted to include a battery.

3. A hearing aid according to claim 1, wherein the hearing aid components accommodated within the closed pinna section includes a microphone.

4. A hearing aid according to claim 1, wherein the hearing aid components accommodated within the closed pinna section includes a digital signal processor.

5. A hearing aid according to claim 1, further having a sound tube for transmission of sound from a receiver positioned in the pinna section to the output port of the canal section.

6. A hearing aid according to claim 1, further having a moulded channel in the canal section for transmission of sound from a receiver positioned in the pinna section to the output port of the canal section.

7. A hearing aid according to claim 1, further having a conductor for connection of a sound processor positioned in the pinna section with a receiver positioned in the canal section for emission of sound through the output port of the canal section.

8. A hearing aid according to any of the previous claims, further comprising a cerumen filter positioned in the canal section.

9. A hearing aid according to any of the previous claims, wherein the pinna section and the canal section form an integral housing that is manufactured in one piece.

10. A hearing aid according to claim 1, wherein the pinna section and the canal section are manufactured as separate parts that are interconnected mechanically and electrically during production of the hearing aid.

11. A hearing aid according to claim 1, wherein the pinna section is connected to a helix section for accommodation of at least one microphone and adapted to be positioned in the helix of the ear of the user.

12. A hearing aid according to claim 11, further comprising a bridge section connecting the pinna and helix sections.

13. A hearing aid according to claim 12, wherein the bridge section and/or the helix section accommodates hearing aid components.

14. A hearing aid according to claim 1, wherein the canal section further comprises a tube, the inner volume of the tube communicating with the vent opening in the wall of the canal section thereby extending the longitudinal extension of the vent.
